(19) United States
(12) Patent Application Publication
(10) Pub. No.: US 2017/0238576 A9
(43) Pub. Date: Aug. 24, 2017

(54) GUM BASES CONTAINING NON-UNIFORM CROSSLINKED POLYMER MICROPARTICLES

(71) Applicants: Xiaohu Xia, Evanston, IL (US); Tawfik Sharkasi, Chicago, IL (US); Philip Shepherd, Glenview, IL (US)

(72) Inventors: Xiaohu Xia, Evanston, IL (US); Tawfik Sharkasi, Chicago, IL (US); Philip Shepherd, Glenview, IL (US)

(21) Appl. No.: 12/951,946

(22) Filed: Nov. 22, 2010

Related U.S. Application Data
(63) Continuation-in-part of application No. 12/806,202, filed on Nov. 23, 2009.

(51) Int. Cl. B32B 5/00; C08F 120/18

(52) U.S. Cl. CPC A23G 4/08

(57) ABSTRACT

A gum base comprises nanoparticles and/or non-uniform microparticles containing at least one crosslinked polymer. Non-uniform microparticles may be in the form of polymer composite microparticles, hollow shell microparticles and/or core-shell microparticles. It has been found that such gum bases exhibit desirable chewing properties similar to conventional gum bases. Cuds formed by chewing gum bases containing crosslinked polymer microparticles are easily removable from environmental surfaces such as concrete, fabrics and flooring materials.

### CROSS-REFERENCE TO RELATED APPLICATION

This application claims benefit to U.S. Provisional Application No. 61/263,462 filed Nov. 23, 2009, incorporated by reference herein.

### BACKGROUND OF THE INVENTION

The present invention relates to gum bases and chewing gums. More specifically, this invention relates to improved chewing gum bases and chewing gums with enhanced removability, as well as methods of manufacturing the gum bases.

The precursor's to today's chewing gum compositions were developed in the nineteenth century. Today's version is enjoyed daily by millions of people worldwide.

When chewing gum is chewed, water soluble components, such as sugars and sugar alcohols are released with varying degrees of speed within the mouth, leaving a water insoluble chewing gum cud. After some amount of time, typically after the majority of the water soluble components have been released therefrom, the cud may be disposed of by the user. Although typically not problematic when disposed of properly, e.g., when wrapped in a substrate such as the original wrapper, or disposed of in a proper receptacle, improper disposal of chewing gum cuds can result in adhesion of cuds to environmental surfaces such as sidewalks, walls, flooring, clothing and furniture.

Conventional elastomers and gum bases used in commercial chewing gum products behave as viscous liquids which provide flow and elasticity characteristics which contribute to their desirable chewing properties. However, when the chewed cuds formed from such conventional chewing gum products become undesirably adhered to rough environmental surfaces such as concrete, over time, the elastomeric components flow into the pores, cracks and crevices of such surfaces. The process may be exacerbated by exposure to pressure (for example through foot traffic) and temperature cycling. If not removed promptly, adhered gum cuds can be extremely difficult to remove from these environmental surfaces.

Thus there is a need for a gum base and chewing gum comprising the same that exhibits the desired characteristics for consumer acceptability, while also producing a cud which is easily removable from surfaces onto which it may have become adhered.

### SUMMARY OF THE INVENTION

A gum base comprises nanoparticles and/or non-uniform microparticles containing at least one crosslinked polymer. Non-uniform microparticles may be in the form of polymer composite microparticles, hollow shell microparticles and/or core-shell microparticles. It has been found that such gum bases exhibit desirable chewing properties similar to conventional gum bases. Cuds formed by chewing gum bases containing crosslinked polymer microparticles are easily removable from environmental surfaces such as concrete, fabrics and flooring materials.

### DESCRIPTION OF THE DRAWINGS

These and other features, aspects and advantages of the present invention will become better understood when the following detailed description is read with reference to the accompanying drawings wherein:

FIG. 1 is a graphical depiction of the shear storage modulus at 37° C. of a gum cud prepared from a comparative chewing gum formulation and of a gum cud prepared from a gum base of the present invention; and

FIG. 2 is a graphical depiction of the shear loss modulus at 37° C. of a gum cud prepared from one embodiment of a chewing gum formulation and of a gum cud prepared from a gum base of the present invention as described herein.

FIG. 3 is a drawing of a polymer composite microparticle of the present invention.

FIG. 4 is a schematic depiction of a process for preparing hollow shell microparticles of the present invention.

FIG. 5 is a photomicrograph of a hollow shell microparticle of the type claimed in some embodiments of the present invention.

FIG. 6 is a cutaway drawing of a core-shell microparticle of the present invention.

### DESCRIPTION OF THE INVENTION

The present invention relates to gum bases which incorporate crosslinked polymer microparticles of a type previously known and used to form pressure sensitive adhesives used in a variety of applications. It has now been surprisingly discovered that such crosslinked polymer microparticles can be used to prepare gum bases having a variety of desirable attributes.

In some embodiments, the crosslinked polymeric microparticles may be nonuniform. By non-uniform, it is meant that the microparticles have a structure other than a chemically and physically homogenous particle. In some embodiments, the non-uniform crosslinked polymeric microparticles may be in the form of a polymer composite of two or more different crosslinked polymeric microparticle components covalently bonded together at their contacting surfaces. The microparticle components are themselves microparticles, the term microparticle components being used to distinguish these from microparticles in finished form which are used in other embodiments of the present invention. By different, it is meant that the microparticle components come from different populations of microparticles which differ in some property such as average particle size, polymeric composition, degree of crosslinking or other physical or chemical property or properties such that, if they were used separately, they would convey different properties to a chewing gum product made from them. By covalently bonding two or more different particle components together and incorporating the resulting polymer composite into a chewing gum product, the texture and chewing properties can be carefully adjusted to produce a product with the desired attributes.

In some embodiments, the non-uniform microparticle will be in the form of a hollow shell. By hollow shell, it is meant that the roughly spherical microparticle is a shell that substantially or completely surrounds a void within the shell. Such voids may constitute 5 to 90% or 20 to 75% of the volume of the hollow shell microparticle. Such hollow shell microparticles will have different textural properties such as a softer texture and greater elasticity as compared to a solid microparticle of the same size and polymeric composition.

In some embodiments, the non-uniform microparticles will be in the form of a core-shell or filled shell. Such embodiments are similar to that of the hollow shell except that, instead of a void, the shell substantially or completely surrounds a solid or liquid core. The core may be a liquid such as water, vegetable oil, glycerin, hydrogels, an aqueous flavor emulsion. Alternatively, the core may be a solid such as a sugar or sugar alcohol granule or particle, a wax, a solid fat, a polymer having a different polymeric composition from the shell.

In some embodiments, the microparticles will be nanoparticles. By nanoparticles, it is meant that the microparticles will have a largest diameter (measured as the greatest dimension of the microparticle) of less than 100 nm (0.1 microns), but typically greater than 10 nm. Use of these nanoparticles by themselves or in conjunction with larger crosslinked microparticles and control the texture and chewing properties of a chewing gum.

The crosslinked polymer may have a glass transition temperature of less than about 30° C., or less than about 10° C. or even less than about 0° C. In these, and/or other, embodiments, the crosslinked polymer may have a complex modulus (G*) at 25° C. of less than about 10⁹ dyne/cm², or less than about 10⁷ dyne/cm². In yet other embodiments, the crosslinked polymer may desirably have a complex modulus (G*) of greater than about 10⁴ dyne/cm², or greater than about 10⁵ dyne/cm².

The microparticles may have a largest dimension of at least about 0.1 microns or at least about 0.5 microns or at least about 10 microns. The microparticles may have a largest dimension of less than about 1000 microns, or less than about 500 microns or less than about 100 microns.

In some embodiments, the microparticles may comprise a food grade polymer and may or may not be plasticized. In these, and other, embodiments, the polymer may comprise a polyacrylate, a polyurethane, or copolymers of these. If a polyacrylate is desired, the polyacrylate may be prepared from at least one acrylate monomer comprising isooctyl acrylate, 4-methyl-2-pentyl-acrylate, 2-methylbutyl acrylate, isoamyl acrylate, sec-butyl acrylate, n-butyl acrylate, 2-ethylhexyl acrylate, isodecyl methacrylate, isononyl acrylate, isodecyl acrylate or combinations (i.e. copolymers) of these. In certain embodiments, when a polyacrylate is desirably used, it may be prepared from isoctyl acrylate, 2-ethylhexyl acrylate, n-butyl acrylate, or copolymers of these.

The microparticles may comprise the entirety of the gum base or may comprise from about 0.1 weight percent (wt %) to about 99 wt %, or from about 1 wt % to about 70 wt % or from about 5 wt % to about 40 wt %, based upon the total weight of the gum base.

Although the present gum bases are expected to exhibit enhanced removability, in some embodiments, the gum bases may further comprise at least one removability enhancing component. The removability enhancing component may comprise an amphiphilic polymer, a low tack polymer, a polymer comprising hydrolysable units, an ester or ether of a polymer comprising hydrolysable units, block copolymers or combinations of these.

The inventive gum base may further comprise at least one elastomer, elastomer solvent, softener, plastic resin, filler, emulsifier, or combinations of these. In certain embodiments, the gum base further comprises a filler, e.g., calcium carbonate, talc, amorphous silica, or combinations of these, in amounts of from about 0 wt % to about 5 wt %, based upon the total weight of the gum base.

In another aspect, a chewing gum is provided comprising a first gum base comprising a plurality of microparticles comprising at least one crosslinked polymer. The first gum base may comprise from about 1 wt % to about 98 wt % of the chewing gum, or from about 10 wt % to about 50 wt %, or from about 20 wt % to about 35 wt % of the chewing gum, based upon the total weight of the gum.

The chewing gum may comprise the first gum base as the sole gum base component, or, in other embodiments, may comprise a second, conventional gum base. In such embodiments, the first gum base may comprise from about 0.1 wt % to about 30 wt % of the chewing gum, based upon the total weight of the gum.

In addition to any amounts thereof in the gum base, the chewing gum may include at least one removability enhancing component. In some embodiments, the removability enhancing component included in the chewing gum comprises an emulsifier, that may be encapsulated or spray dried, if desired.

In another aspect, the use of crosslinked polymeric microspheres as a gum base is provided.

And in yet another embodiment, methods for manufacturing a gum base are further provided and comprise the steps of adding an aqueous slurry of crosslinked polymeric microparticles to a mixer, adding at least one of an elastomer, an elastomer solvent, a softener, a resin, a filler and/or an emulsifier to the mixer, mixing the components at elevated temperature for a time sufficient to evaporate at least a majority of the water, and discharging the mixture from the mixer.

Unless defined otherwise, technical and scientific terms used herein have the same meaning as is commonly understood by one of ordinary skill in the art to which this invention belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced item, and the terms “front”, “back”, “bottom”, and/or “top”, unless otherwise noted, are merely used for convenience of description, and are not intended to limit what is being described to any one position or spatial orientation.

Reference is occasionally made herein to a largest dimension of the microparticles disclosed herein. It is to be understood that when particular ranges are indicated as advantageous or desired for these measurements, or that a particular shape of the microparticles may be desirable, that these ranges/shapes may be based upon the measurement or observation of from about 1 to about 10 microparticles, and although it may generally be assumed that a majority of the microparticles may thus exhibit the observed shape or be within the range of largest dimension provided, that the ranges are not meant to, and do not, imply that 100% of the population, or 90%, or 80%, or 70%, or even 50% of the microparticles need to exhibit a shape or possess a largest dimension within this range. All that is required is that a sufficient number of the microparticles exhibit a dimension within the desired range and/or the desired shape so that at least a portion of the desired properties of the microparticles, and thus the gum base and chewing gum, are provided.

If ranges are disclosed, the endpoints of all ranges directed to the same component or property are inclusive and independently combinable (e.g., ranges of “up to about 25 wt %, or, more specifically, about 5 wt % to about 20 wt %,” is inclusive of the endpoints and all intermediate values of the ranges of “about 5 wt % to about 25 wt %,” etc.). The modifier “about” used in connection with a quantity is inclusive of the stated value and has the meaning dictated by the context (e.g., includes the degree of error associated with measurement of the particular quantity). Further, unless otherwise stated, percents listed herein are weight percents (wt %) and are based upon the total weight of the gum base or chewing gum, as the case may be.

The present invention provides gum bases and chewing gums, as well as methods of manufacturing the gum bases. More specifically, the gum bases provided herein comprise microparticles further comprising one or more crosslinked polymer(s). The polymeric microparticles may render a gum cud comprising the gum base more easily removable from surfaces to which it may have become adhered than gum cuds comprising conventional gum bases. Advantageously, the present gum bases also have chew properties consistent with those of conventional gum bases. That is, the gum base comprising the polymeric microparticles is elastic yet deformable, more cohesive than adhesive, and readily recombines if torn apart. As a result, a chewing gum comprising the gum base is expected to enjoy a high consumer-acceptability.

Polymeric microparticles suitable for use in the chewing gum base described herein should be sufficiently pliable at typical mouth temperatures (e.g., 35-40° C.) to give good chewing properties. Further, the polymeric microparticles will desirably be essentially without taste and have an ability to incorporate flavor materials which provide a consumer-acceptable flavor sensation. Typically, the microparticles will have sufficient cohesion such that a chewing gum comprising them retains cohesion during the chewing process and forms a discrete gum cud.

The polymer(s) used will desirably be crosslinked, either before, during or after the formation thereof into microparticles. As used herein, the term “crosslinked” means the linking of the chains of a polymer to one another through covalent or ionic bonds so that the polymer, as a network, becomes stronger and more resistant to being dissolved. Preferably the linkage is through covalent bonds. In at least some embodiments all, or most (i.e., greater than 50% of the polymers, based upon the total number thereof), of the polymers within a microparticle will be crosslinked. In other embodiments, the crosslinking may be incomplete and a minority (i.e., less than 50% of the polymers, based upon the total number of polymers) of the polymers within the microparticle will be crosslinked. However, as long as the crosslinking is sufficient to provide at least a portion of the properties described herein to the gum base and/or chewing gum, the amount of crosslinking will be sufficient for use in at least certain embodiments of the present invention.

Generally speaking, the polymers used in the microparticles may desirably be crosslinked to a sufficient degree as to prevent, or reduce the degree of, permanent deformation of the microparticles when exposed to pressures, temperatures and shear forces expected in the course of manufacture, consumption and disposal. Conversely, the polymer(s) should not be crosslinked to an extent that could result in the microparticle being brittle and/or incapable of being temporarily deformed (even if plasticized). Insufficient polymer crosslinking may result in excessive difficulty in removing cuds comprising the polymeric microparticles from environmental surfaces. On the other hand, excessive polymer crosslinking may result in a gum base that has insufficient adhesion between the microparticles and/or is excessively hard for optimal chewing enjoyment by the consumer.

Those of ordinary skill in the art are readily able to determine a level of crosslinking within these practical limits. For those requiring further guidance, reference can be made to ASTM method D2765, Standard Test Methods for Determination of Gel Content and Swell Ratio of Crosslinked Ethylene Plastics. In general, polymers having a gel content of at least 25%, or at least 50%, or at least 75%, as tested by this method, are considered to have suitable crosslinking for use in the microparticles of the present invention. In some embodiments, polymers having a gel content between about 80% and 100%, as measured by ASTM D-2675, are suitable for use in the microparticles described herein.

Using a crosslinked polymer having an appropriate complex modulus is expected to at least assist in providing the present gum base with appropriate and/or acceptable chew properties.

More particularly, crosslinked polymers having a complex modulus G* at 25° C. of less than about 10⁹ dyne/cm² (10⁸ Pa), less than about 10⁸ dyne/cm² (10⁷ Pa), less than 10⁷ dyne/cm² (10⁶ Pa) or, in some embodiments, even less than about 10⁶ dyne/cm² (10⁵ Pa) can assist in providing chewing gum bases and chewing gums with desirable chew properties. In the case of the polymer(s) having a complex modulus G* at 25° C. or greater than about 10⁷ or 10⁸ dyne/cm² (10⁶ or 10⁷ Pa) or even greater, it may be desirable to combine the polymer with a plasticizer to reduce effective complex modulus G* to ensure proper chewing texture. In some embodiments, the polymer may desirably have a complex modulus G* at 25° C. of greater than about 10⁴ dyne/cm² (10³ Pa) or greater than about 10⁵ dyne/cm² (10⁴ Pa) or even greater than 10⁶ dyne/cm² (10⁵ Pa) to provide a firm texture during chewing.

Using a crosslinked polymer with an appropriate glass transition temperature may also assist in providing the gum base with appropriate and/or acceptable chew properties. Crosslinked polymers having a glass transition temperature of less than about 30° C., or less than about 10° C. or even less than about 0° C., are expected to at least assist in providing the gum base with chew properties similar to, or better than, conventional gum bases.

The crosslinked polymer is desirably safe for use in chewing gums, and potentially ingestion. In some embodiments, the polymer used will be food grade. As used herein, the term ‘food grade’ is meant to indicate that the polymer meets all legal requirements for use in a food product in the intended market. While requirements for being food grade vary from country to country, food grade polymers intended for use as masticatory substances (i.e. gum base) may typically have to: i) be approved by the appropriate local food regulatory agency for this purpose; ii) be manufactured under “Good Manufacturing Practices” (GMPs) which may be defined by local regulatory agencies, such practices ensuring adequate levels of cleanliness and safety for the manufacturing of food materials; iii) be manufactured with food grade materials (including reagents, catalysts, solvents and antioxidants) or materials that at least meet standards for quality and purity; iv) meet minimum standards for quality and the level and nature of any impurities present; v) be provided with an adequately documented manufacturing history to ensure compliance with the appropriate standards; and/or vi) be manufactured in a facility that itself is subject to inspection by governmental regulatory agencies. All of these standards may not apply in all jurisdictions, and all that is required in those embodiments wherein the polymer is desirably food grade is that the polymer meets the standards required by the particular jurisdiction.

For example, in the United States, ingredients are approved for use in food products by the Food and Drug Administration. In order to gain approval for a new food or color additive, a manufacturer or other sponsor must petition the FDA for its approval. Petition is not necessary for prior-sanctioned substances or ingredients generally recognized as safe (GRAS ingredients) and these are specifically included within the meaning of the term “food grade” as used herein. Information on the regulatory process for food additives and colorants in the U.S. can be found at http://www.fda.gov/Food/FoodIngredientsPackaging/ucm094211.htm, the entire contents of which are incorporated by reference herein for any and all purposes.

In Europe, one example of a governing agency is the European Commission, Enterprise and Industry. Information of the European Commission's regulation of the food industry in Europe can be found at http://ec.europa.eu/enterprise/sectors/food/index_en.htm, the entire contents of which are incorporated by reference herein for any and all purposes.

Any polymer(s) capable of exhibiting at least a portion of the desired properties may be suitable for use in the microparticles, and thus gum base, described herein. Polymers that are capable of exhibiting the desired properties if plasticized sufficiently are also suitable for use. Examples of such polymers include, but are not limited to, grafted acrylic polymers, polyurethanes and grafted polyolefins with side groups greater than four carbon atoms. Graft or block copolymers of these are also suitable

Examples of polymers that are expected to exhibit the desired properties for use in the formation of the microparticles without the use of substantial amounts of plasticizer, include, but are not limited to polyacrylates, polyurethanes, graft or block copolymers of these. Other crosslinked polymers which might otherwise be above the desirable T_{g} and/or modulus ranges may be used if the crosslinked polymers are suitably plasticized to reduce the T_{g} and/or modulus values to within the desirable ranges. Combinations of any of these are also suitable. The desired polymer may typically be prepared from one or more monomer(s). Suitable monomers will depend upon the polymer desirably being prepared.

In preferred embodiments, the polymer comprises at least one crosslinked polyacrylate that, in further preferred embodiments may be prepared from one or more acrylate monomers. Suitable acrylate monomers include monofunctional unsaturated acrylate and/or methacrylate esters of non-tertiary alkyl alcohols, wherein the alkyl groups contain from about 4 to about 14 carbon atoms, and a multifunctional crosslinking agent.

Examples of monofunctional acrylate monomers suitable for use in preparing the polyacrylate thus include, but are not limited to, isooctyl acrylate, 4-methyl-2-pentyl-acrylate, 2-methylbutyl acrylate, isoamyl acrylate, sec-butyl acrylate, n-butyl acrylate, 2-ethylhexyl acrylate, isodecyl methacrylate, isononyl acrylate, isodecyl acrylate and mixtures thereof. Among these, isooctyl acrylate, 2-ethylhexyl acrylate, n-butyl acrylate or combinations of these are preferred for use in some embodiments of the gum base.

At least one crosslinking agent may be used to produce the crosslinked polymer. The crosslinking agent(s) chosen, and effective amounts thereof, will depend on the polymer desirably crosslinked, and can be readily selected and optimized by those of ordinary skill in the art. In those embodiments wherein the polymer desirably comprises a polyacrylate, suitable crosslinking agents include multifunctional acrylates, such as trimethylolpropane triacrylate (TMPTA); epoxy group containing compounds; alkylenimines; organoalkoxysilanes; or combinations of these.

The crosslinked polymer is desirably provided in the form of a microparticle, i.e., a particle having a largest dimension of at least about 0.1 microns or at least about 0.5 microns or at least about 10 microns. The microparticles may have a largest dimension of less than about 1000 microns, or less than about 500 microns or less than about 100 microns. While not wishing to be bound by any theory, it is believed that providing the crosslinked polymer in such a form can assist in enhancing the removability of the gum bases and chewing gums, e.g., since the microparticles are of a size that will not allow them to flow into the topography of many environmental surfaces, while yet preserving the chewability of the gum bases and chewing gums.

The shape of the microparticles is not critical and they may be irregularly shaped, or of any shape, e.g., the particles may be in the form of rods, cylinders, spheres, cubes, ovals, etc. In some embodiments, the microparticles may be generally spherical. In such embodiments, the generally spherical microparticles may desirably have diameters of from about 0.1 microns to about 1000 microns, or from about 0.5 microns to about 500 microns, or even from about 10 microns to about 100 microns.

The desired polymer may be formed into microparticles by any of a number of techniques known to those of ordinary skill in the art. Or, the desired polymer may be purchased in a microparticle form from any of a number of commercial sources. Polyacrylate microparticles, for example, are commercially available from Avery Dennison (Pasadena, Calif.) under the tradename Ultra-Removable Adhesive.

If desirably prepared, the polymers may be provided in a microparticle form by a suspension polymerization process in which one or more monofunctional monomers are reacted along with at least one multifunctional crosslinking agent. The reactants will be present as suspended droplets, preferably by subjecting them to mechanical dispersion in an appropriate continuous phase. The particle size of the microparticles can be controlled by adjusting the ratio of the phases, with a greater imbalance in the ratio tending to produce smaller microparticles. Particle size may also be controlled via use of a surfactant, and the adjustment of any amounts thereof or through variations in the temperature of the reaction. Increasing the intensity of agitation will also tend to produce smaller microparticles.

Alternatively, if the microparticles are provided in the form of a water dispersion, they may be mechanically separated from the dispersion medium by mechanical means such as centrifugation, precipitation or filtration before blending with other gum base or chewing gum components. The microparticles may also be separated through evaporation of the dispersion medium.

One exemplary method for providing the desired polymer in the form of microparticles is described in U.S. Pat. No. 3,691,140, incorporated by reference herein in its entirety, to the extent that it is not contradictory with the teachings provided herein.

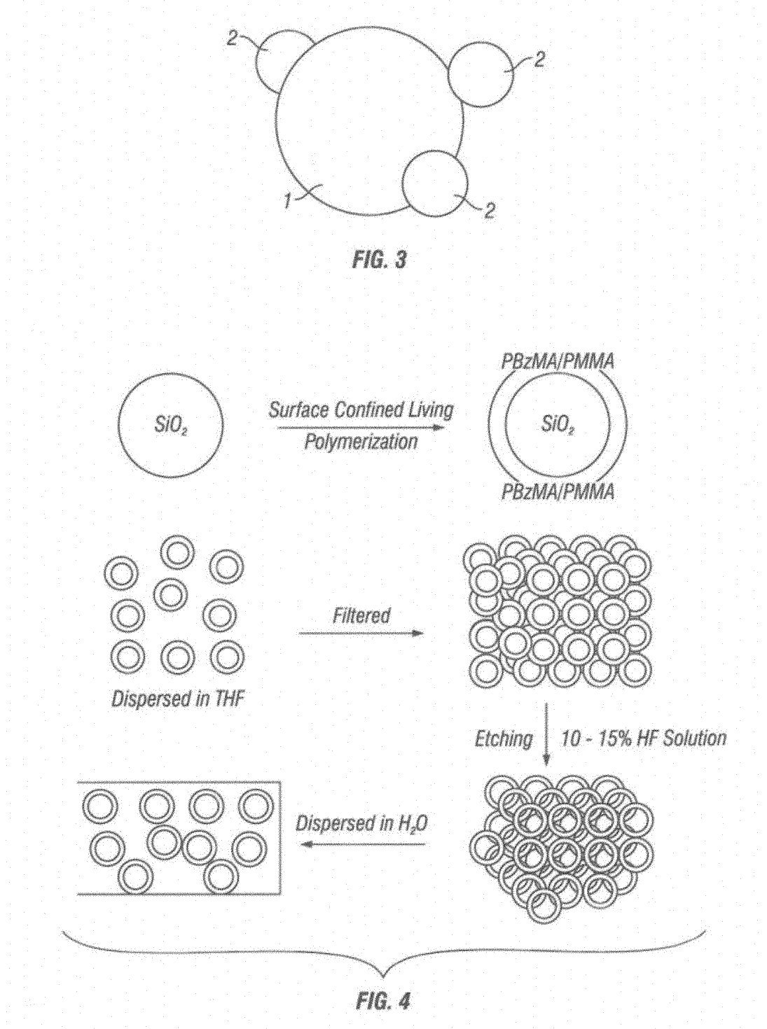

Non-uniform microparticles in the form of a polymer composite can be prepared as follows. First, two batches of crosslinked polymeric microparticles having different chemical or physical properties (such as size) are prepared under an inert (i.e. oxygen-free) atmosphere to prevent termination of the polymerization reaction as previously described. After the microparticles are substantially formed, the surfaces of the microparticles of both batches stay active for further growth under the inert atmosphere. The two batches are the combined while maintaining the inert atmosphere. This allows the microparticles to react and covalently and/or ionically bond with each other on their surfaces to produce the polymer composite. Finally, oxygen is introduced into the atmosphere to terminate the reaction. A microparticle in the form of a polymer composite having a large diameter microparticle component (1) and a number of smaller diameter microparticle components (2) covalently bonded to its surface is illustrated in FIG. 3.

Non-uniform microparticles in the form of a hollow shell can be prepared as follows. A template particle, such as a particle of silicon dioxide is introduced into a monomer emulsion or suspension. Polymerization is allowed to occur which results in a polymeric coating on the surface of the template particle. After polymerization is complete, the coated particles are collected and etched with using a reagent capable of dissolving the template particle but not the polymeric coating, such as a hydrofluoric acid solution. After the reagent has dissolved the template particles, the hollow polymeric microparticles are collected and washed to remove the reagent. This process is illustrated in FIG. 4. Processes for making a hollow shell microparticle of the type described are described in the following papers which are hereby incorporated by reference: Template Synthesis of Hydrogel Composite Hollow Spheres Against Polymeric Hollow Latex, by Wei Wei et al. Colloid & Polymer Science, 286, 881-888; Template Synthesis of Composite Hollow Spheres Using Sulfonated Polystyrene Hollow Spheres, By Shu-Jiang Ding et al. Polymer 47, 25, 8360-8366; and Direct Synthesis of Polymer Nanocapsules Self-Assembly of Polymer Hollow Spheres Through Irreversible Covalent Bond Formation, by Kim D. et al. JACS 2010 132(28), 9908-19. A photomicrograph of a hollow shell microparticle of the type described is shown in FIG. 5.

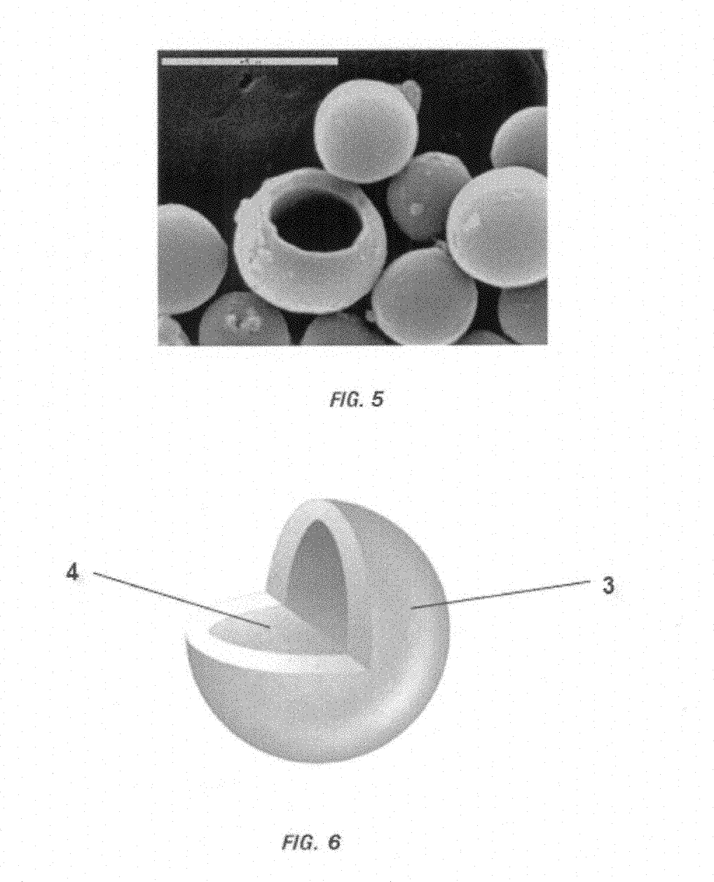

Non-uniform microparticles in the form of a core-shell can be prepared by surface-initiated atom transfer radical polymerization (ATRP). Such processes are disclosed in the following papers which are hereby incorporated by reference: PLGA-Lecithin-PEG Core-Shell Nanoparticles for Controlled Drug Delivery, by Robert Langer et al, Biomaterials 30 (2009), 1627-1634; Preparation of Core-Shell Type Polymer Microspheres from Anionic Block Copolymers, by Koji Ishizu, Fumihiro Naruse and Reiko Saito Polymer, 34, 18, 1993, 3929-3933); Synthesis of Core-Shell Polymer Microspheres by Two-Stage Distillation-Precipitation Polymerization, by Donglai Qi, Feng Bai, Xinlin Yang and Wenqiang Huang, European Polymer Journal, 41, 10, 2005, 2320-2328; and Inorganic-Polymer Core Shell Hybrid Microspheres, by Longyu Li, Dianbin Qin, Xinlin Yang and Guangyu Liu, Colloid & Polymer Science, 288, 199-206. A core-shell microparticle having a crosslinked polymer shell (3) and a solid or liquid core (4) is shown in FIG. 6.

Microparticles in the form of nanoparticles can be prepared by altering the conditions used to make larger crosslinked polymeric microparticles. Such modifications may include using a higher emulsifier level, more vigorous agitation of the emulsion or a combination of these methods.

The above described methods of forming the crosslinked polymeric microparticles of the present invention are exemplary only and the present invention is not limited to the described processes. The use of other methods, whether or not currently known, are specifically contemplated. Any method of producing the described crosslinked polymeric microbeads is acceptable. The gum bases described herein contain at least one population of the microparticles described herein, although it is to be understood that the gum base may comprise any number of such populations. In such embodiments, each population may comprise the same polymer, but may be processed differently or comprise different additional components, so that the properties of each population are different. Or, each of the populations may comprise the same polymer, but one population of microparticles may have a different particle size distribution or average largest dimension than the other(s). For example, a population of nanoparticles may be combined with populations of microparticles having greater average largest dimension. Of course, each of the populations may also comprise a different polymer, or combinations of polymers, etc. In addition, populations of microparticles in the form of polymer composite microparticles, hollow shell microparticles and core-shell microparticles may be combined with each other or with populations of solid microparticles which comprise a single polymer or copolymer in any desired combination. The blending of different populations of microparticles provides greater control and flexibility over the texture and chewing properties of the finished product.

The microparticles may be the sole component of the gum base described herein, or the gum base may comprise additional ingredients, if desired. For example, the microparticles may comprise from about 0.1 wt % to about 99 wt %, or from about 1 wt % to about 70 wt %, or from about 5 wt % to about 40 wt %, based upon the total weight of the gum base.

In order to further enhance the removability of cuds formed from chewing gums comprising the gum bases described herein, it may be desirable to incorporate other known removability-enhancing features into the gum base and/or chewing gum.

For example, certain additives such as emulsifiers and amphiphilic polymers may be added. Another additive which may prove useful is a polymer having a straight or branched chain carbon-carbon polymer backbone and a multiplicity of side chains attached to the backbone as disclosed in WO 06-016179 hereby incorporated by reference herein in its entirety for any and all purposes, to the extent that it is not contradictory to the teachings provided herein. Still another additive which may enhance removability is a polymer comprising hydrolyzable units or an ester and/or ether of such a polymer. One such polymer comprising hydrolyzable units is a copolymer sold under the Trade name Gantrez®. Addition of such polymers at levels of from about 1 wt % to about 20 wt % based upon the total weight of the chewing gum base may reduce adhesion of discarded gum cuds.

Another approach to enhancing removability of the present invention involves formulating gum bases to contain less than 5% (i.e. 0 to 5%) of a calcium carbonate and/or talc filler and/or 5 to 40% amorphous silica filler. Formulating gum bases to contain 5 to 15% of high molecular weight polyisobutylene (for example, polyisobutylene having a weight average or number average molecular weight of at least 200,000 Daltons) is also effective in enhancing removability.

In those embodiments of the invention wherein the gum base desirably includes ingredients or components in addition to the microparticles, any components typically found in gum bases may be included. For example, the microparticles may be combined with one or more elastomers, elastomer solvents, softeners, resins, fillers, colors, antioxidants, emulsifiers or mixtures thereof and other conventional gum base components.

In some embodiments, the microparticles may be used as the sole elastomer, while in others, the microparticles may be combined with other base elastomers, and elastomer solvents suitable for use in gum bases.

In some embodiments, significant amounts (more than 1 wt %) of these conventional elastomers and elastomer solvents are not incorporated into a gum base of the present invention, i.e., the elastomer component of gum bases disclosed herein may contain up to about 100 wt % of the microparticles disclosed herein.

In other embodiments, mixtures of the microparticles with any of the elastomers described below may be used in the present gum bases. For example, the present gum bases may include at least about 10 wt %, or at least about 30 wt %, or at least about 50 wt % or even at least about 70 wt % microparticles by weight of the total elastomer content, in combination with any other desired elastomer(s).

A typical elastomeric component of the gum bases described herein contains between 10 wt % to 100 wt % microparticles and preferably 50 wt % to 100 wt % microparticles. A gum base having an elastomer component containing from about 75 wt % to about 90 wt %, or from about 90 wt % to about 100 wt. % microparticles is also useful.

Suitable other elastomers, where used, include synthetic elastomers including polyisobutylene, isobutylene-isoprene copolymers (butyl rubber), styrene-butadiene copolymers, polyisoprene and combinations thereof. Natural elastomers that can be used include natural rubbers such as chicle, jelutong, lechi caspi, perillo, sorva, massaranduba balata, massaranduba chocolate, nispero, rosindinha, chicle, gutta hang kang, and combinations thereof. Additionally, biopolymers, such as those based on modified or unmodified proteins and carbohydrates, may be used as elastomers. Such biopolymers may have the advantage of enhancing the biodegradability of the gum cud after it is discarded.

Elastomer solvents commonly used for synthetic elastomers may be optionally used in this invention including but are not limited to, natural rosin esters, often called estergums, such as glycerol esters of partially hydrogenated rosin, glycerol esters of polymerized rosin, glycerol esters of partially or fully dimerized rosin, glycerol esters of rosin, pentaerythritol esters of partially hydrogenated rosin, methyl and partially hydrogenated methyl esters of rosin, pentaerythritol esters of rosin, glycerol esters of wood rosin, glycerol esters of gum rosin; synthetics such as terpene resins derived from alpha-pinene, beta-pinene, and/or d-limonene; and any suitable combinations of the foregoing. The preferred elastomer solvents also will vary depending on the specific application, and on the type of elastomer which is used.

Softeners (including emulsifiers) may be added to gum bases in order to optimize the chewability and mouth feel of a chewing gum based upon the same. Softeners/emulsifiers that typically are used include tallow, hydrogenated tallow, hydrogenated and partially hydrogenated vegetable oils, cocoa butter, mono- and di-glycerides such as glycerol monostearate, glycerol triacetate, lecithin, paraffin wax, microcrystalline wax, natural waxes and combinations thereof. Lecithin and mono- and di-glycerides also function as emulsifiers to improve compatibility of the various gum base components. Further, a typical gum base may include at least about 5 wt %, or at least about 10 wt % softener, or up to about 30 wt % and more typically up to about 40 wt % softener, based upon the total weight of the gum base.

The gum bases of the present invention may optionally include plastic resins. These include polyvinyl acetate, vinyl acetate-vinyl laurate copolymer having vinyl laurate content of about 5 to about 50 percent by weight of the copolymer, and combinations thereof. Preferred weight average molecular weights (by GPC) for polyvinyl acetate are 2,000 to 90,000 or 10,000 to 65,000 (with higher molecular weight polyvinyl acetates typically used in bubble gum bases). For vinyl acetate-vinyl laurate, vinyl laurate content of from about 10 wt % to about 45 wt % of the copolymer is preferred. Where used, plastic resins may constitute 5 to 35 wt. % of the gum base composition.

Fillers/texturizers typically are inorganic, water-insoluble powders such as magnesium and calcium carbonate, ground limestone, silicate types such as magnesium and aluminum silicate, clay, alumina, talc, titanium oxide, mono-, di- and tri-calcium phosphate and calcium sulfate. Insoluble organic fillers including cellulose polymers such as wood as well as combinations of any of these also may be used. If used, fillers may typically be included in amounts from about 4 wt % to about 50 wt % filler, based upon the total weight of the gum base. However, in some embodiments, it is preferred that the use of common inorganic fillers be minimized such as by limiting their use to less than 5 wt. % and preferably less than 3 wt. % or even 0 percent as a means of further reducing the adhesive properties of the chewed cud.

Colorants and whiteners may include FD&C-type dyes and lakes, fruit and vegetable extracts, titanium dioxide, and combinations thereof. Antioxidants such as BHA, BHT, tocopherols, propyl gallate and other food acceptable antioxidants may be employed to prevent oxidation of fats, oils and elastomers in the gum base.

The gum base described herein may include wax or be wax-free. An example of a wax-free gum base is disclosed in U.S. Pat. No. 5,286,500, the disclosure of which is incorporated herein by reference to the extent that it is consistent with the teachings provided herein. It is preferred that the gum bases of the present invention be free of paraffin wax.

A typical gum base useful in this invention may include from about 0.1 wt % to about 98 wt % microparticles, from about 0 wt % to about 20 wt % synthetic elastomer, from about 0 wt % to about 20 wt % natural elastomer, from about 0 wt % to about 40 wt % elastomer solvent, from about 0 wt % to about 50 wt % filler/texturizer, from about 0 wt % to about 40 wt. % softener/emulsifier, from about 5 wt % to about 35 wt % plastic resin, and about 2 wt % or less, or less than about 1 wt % of miscellaneous ingredients such as colorants, antioxidants, and the like.

The microparticles may be processed into the gum base according to any known method of doing so. The microparticles may be used as prepared or purchased, typically in an aqueous suspension. In those embodiments wherein the microparticles are provided or purchased as a suspension, the microparticle suspension may be dehydrated prior to inclusion in, or use as, the gum base.

If used as an aqueous suspension, one exemplary method of manufacturing a gum base comprising the polymeric microparticles includes adding the microparticle suspension to a mixer followed by at least one of an elastomer, an elastomer solvent, a filler/texturizer, emulsifier/softener, plastic resin, color and/or antioxidant to the mixer. the desired components are mixed at elevated temperature, e.g., from about 100° C. to about 120° C., for a time sufficient to evaporate at least a majority of the liquid, and discharging the gum base from the mixer. Any desired additional ingredients may be added by conventional batch mixing processes or continuous mixing processes. Process temperatures are generally from about 120° C. to about 180° C. in the case of a batch process.

If it is desired to combine the polymeric microparticles with conventional elastomers, it is preferred that the conventional elastomers be formulated into a conventional gum base before combining with the microparticle gum base.

To produce a conventional gum base, the elastomers are typically first ground or shredded along with at least a portion of any desired filler. Then the ground elastomer is transferred to a batch mixer for compounding. Any standard, commercially available mixer (e.g., a Sigma blade mixer) may be used for this purpose. Compounding typically involves combining the ground elastomer with filler and elastomer solvent and mixing until a homogeneous mixture is produced, typically for about 30 to about 70 minutes.

Thereafter, any desired additional filler and elastomer plasticizer(s) are added followed by softeners, while mixing to homogeneity after each addition. Minor ingredients such as antioxidants and color may be added at any time in the process. The conventional base is then blended with the microparticle-containing gum base in the desired ratio.

Where microparticles are combined with conventional elastomers and/or other base components, the completed base may be extruded or cast into any desirable shape (e.g., balls, pellets, sheets or slabs) and allowed to cool and solidify. In some cases, it may be preferable to use an underwater pelletization process for this purpose.

Alternatively, the gum base may be compounded with both conventional elastomers and microparticles, or, any desired conventional elastomers and the polymeric microparticles may be added separately to a gum base mixing operation along with other chewing gum components.

Continuous processes using mixing extruders, which are generally known in the art, may also be used to prepare the gum base. In a typical continuous mixing process, initial ingredients (including ground elastomer, if used) are metered continuously into extruder ports various points along the length of the extruder corresponding to the batch processing sequence. If the microparticles are to be compounded into the base, a metering extruder or other specialized means to meter the microparticles into the compounding extruder may be used.

After the initial ingredients have mixed homogeneously and have been sufficiently compounded, the balance of the base ingredients are metered into ports or injected at various points along the length of the extruder. Typically, any remainder of elastomer component or other components are added after the initial compounding stage. The composition is then further processed to produce a homogeneous mass before discharging from the extruder outlet. Typically, the transit time through the extruder will be less than an hour.

Exemplary methods of extrusion, which may optionally be used in accordance with the present invention, include the following, the entire contents of each being incorporated herein by reference to the extent that they do not contradict the teachings herein: (i) U.S. Pat. No. 6,238,710, which describes a method for continuous chewing gum base manufacturing, which entails compounding all ingredients in a single extruder; (ii) U.S. Pat. No. 6,086,925 which discloses the manufacture of chewing gum base by adding a hard elastomer, a filler and a lubricating agent to a continuous mixer; (iii) U.S. Pat. No. 5,419,919 which discloses continuous gum base manufacture using a paddle mixer by selectively feeding different ingredients at different locations on the mixer; and, (iv) U.S. Pat. No. 5,397,580 which discloses continuous gum base manufacture wherein two continuous mixers are arranged in series and the blend from the first continuous mixer is continuously added to the second extruder.

A typical gum base comprising the microparticles as described herein may desirably have a shear modulus (the measure of the resistance to the deformation) of from about 1 kPa (10000 dyne/cm²) to about 600 kPa (6×10⁶ dyne/cm²) at 40° C. (measured on a Rheometric Dynamic Analyzer with dynamic temperature steps, 0-100° C. at 3° C./min; parallel plate; 0.5% strain; 10 rad/s). A preferred gum base according to some embodiments of the present invention may have a shear modulus of from about 5 kPa (50000 dyne/cm²) to about 300 kPa (3×10⁶ dyne/cm²), or even from about 10 kPa (1×10⁵ dyne/cm²) to about 70 kPa (7×10⁵ dyne/cm²).

A variety chewing gum formulations including the gum bases described herein can be created and/or manufactured in accordance with the present invention. Because of the inclusion of the polymeric microparticles described herein into the inventive gum base and chewing gum, a gum cud formed from the chewing gum is more easily removed from surfaces onto which it may become adhered than gum cuds formed from chewing gums comprising conventional gum bases.

The gum base described herein may constitute from about 0.1 wt % to about 98 wt % by weight of the chewing gum. More typically, the inventive gum base may constitute from about 10 wt % to about 50 wt % of the chewing gum and, in various preferred embodiments, may constitute from about 20 wt % to about 35% by weight of the chewing gum.

In some embodiments, the gum bases described herein may be used to replace conventional gum bases in chewing gum formulas. In such embodiments, the gum base may comprise from about 15 wt % to about 50 wt % of the chewing gum.

Or, the gum bases described herein may be used in combination with conventional gum bases, in any amount or ratio. In such embodiments, the gum base described herein may comprise from about 0.1 wt % to about 30 wt % of the chewing gum.

Any of the removability enhancing components discussed herein may also be added to the chewing gum, either instead of, or in addition to, any amount thereof added to the gum base. For example, a polymer comprising hydrolysable units or an ester or ether of such a polymer may be added to the chewing gum at levels of from about 1 wt % to about 7 wt % based upon the total weight of the chewing gum.

Further, in some embodiments, high levels of emulsifiers such as powdered lecithin may be incorporated into the chewing gum at levels of 3 to 7% by weight of the chewing gum in order to enhance the removability of gum cuds produced therefrom. In such embodiments, it may be advantageous to spray dry or otherwise encapsulate the emulsifier to delay its release.

Any combination of any number of the described approaches may be employed simultaneously to achieve improved removability. Further, and as described above, the described removability enhancing components, or any other components known to those of ordinary skill in the art to be useful for this purpose, may be incorporated into the gum base and/or chewing gum.

In one exemplary embodiment, removability of gum cuds formed from the chewing gums comprising the gum bases disclosed herein can be further enhanced by incorporating at least one of from about 0 wt % to about 5 wt % of a calcium carbonate or talc filler, from about 5 wt % to about 40 wt % amorphous silica filler, from about 5 wt % to about 15 wt % high molecular weight polyisobutylene, from about 1 wt % to about 20 wt % of a polymer having a straight or branched chain carbon-carbon polymer backbone and a multiplicity of side chains attached to the backbone, based upon the total weight of the gum base, into the gum base. The gum base according to this embodiment may then be formed into a chewing gum further comprising 3 to 7% of an emulsifier, such as lecithin, which is preferably encapsulated such as by spray drying.

In addition to the gum base, chewing gum typically includes a bulk portion which may include bulking agents, high intensity sweeteners, one or more flavoring agents, water-soluble softeners, binders, emulsifiers, colorants, acidulants, antioxidants, and other components that provide attributes desired by consumers of chewing gum. Any or all of these may be included in the present chewing gums.

In some embodiments, one or more bulking agent(s) or bulk sweetener(s) may be provided in chewing gums described herein to provide sweetness, bulk and texture to the chewing gum. Bulking agents may also be selected to allow marketing claims to be used in association with the chewing gums. That is, if it is desirable to promote a chewing gum as low calorie, low calorie bulking agents such as polydextrose may be used, or, if the chewing gum is desirably promoted as comprising natural ingredients, natural bulking agents such as isomaltulose, inulin, agave syrup or powder, erythritol, starches and some dextrins may be used. Combinations of any of the above bulking agents may also be used in the present invention.

Typical bulking agents include sugars, sugar alcohols, and combinations thereof. Sugar bulking agents generally include saccharide-containing components commonly known in the chewing gum art, including, but not limited to, sucrose, dextrose, maltose, dextrin, dried invert sugar, fructose, levulose, galactose, corn syrup solids, and the like, alone or in combination. In sugarless gums, sugar alcohols such as sorbitol, maltitol, erythritol, isomalt, mannitol, xylitol and combinations thereof are substituted for sugar bulking agents.

Bulking agents typically constitute from about 5 wt % to about 95 wt % of the total weight of the chewing gum, more typically from about 20 wt % to about 80 wt % and, still more typically, from about 30 wt % to about 70 wt % of the total weight of the chewing gum.

If desired, it is possible to reduce or eliminate the bulking agent to provide a reduced calorie or calorie-free chewing gum. In such embodiments, the microparticles/gum base may comprise up to about 98 wt % of the chewing gum. Or, a low caloric bulking agent can be used. Examples of low caloric bulking agents include, but are not limited to, polydextrose; Raftilose; Raftilin; fructooligosaccharides (NutraFlora®); Palatinose oligosaccharide; Guar Gum Hydrolysate (Sun Fiber®); or indigestible dextrin (Fibersol®). The caloric content of a chewing gum can also be reduced by increasing the relative level of gum base while reducing the level of caloric sweeteners in the product. This can be done with or without an accompanying decrease in piece weight.

For example, in these and other embodiments, high intensity artificial sweeteners can be used alone or in combination with the bulk sweeteners. Preferred sweeteners include, but are not limited to sucralose, aspartame, salts of acesulfame, alitame, neotame, saccharin and its salts, cyclamic acid and its salts, glycyrrhizin, stevia and stevia derivatives such as Rebaudoside A, dihydrochalcones, lo han guo, thaumatin, monellin, etc., or combinations of these. In order to provide longer lasting sweetness and flavor perception, it may be desirable to encapsulate or otherwise control the release of at least a portion of the artificial sweetener. Techniques such as wet granulation, wax granulation, spray drying, spray chilling, fluid bed coating, coacervation, and fiber extrusion may be used to achieve the desired release characteristics.

Usage level of the artificial sweetener will vary greatly and will depend on such factors as potency of the sweetener, rate of release, desired sweetness of the product, level and type of flavor used and cost considerations. Generally speaking, appropriate levels of artificial sweeteners thus may vary from about 0.02 wt % to about 8 wt %. When carriers used for encapsulation are included, the usage level of the encapsulated sweetener will be proportionately higher.

A variety of natural or artificial flavoring agents, and may be used in any number or combination, if desired. Flavoring agents may include essential oils, natural extracts, synthetic flavors or mixtures thereof including, but not limited to, oils derived from plants and fruits such as citrus oils, fruit essences, peppermint oil, spearmint oil, other mint oils, clove oil, oil of wintergreen, anise and the like.

Artificial flavoring agents and components may also be used. Sensate components which impart a perceived tingling or thermal response while chewing, such as a cooling or heating effect, also may be included. Such components include cyclic and acyclic carboxamides, menthol and menthol derivatives such as menthyl esters of food acceptable acids, and capsaicin among others. Acidulants may be included to impart tartness.

The desired flavoring agent(s) can be used in amounts of from approximately 0.1 wt % to about 15 wt % of the gum, and preferably, from about 0.2 wt % to about 5 wt %.

Water-soluble softeners, which may also be known as water-soluble plasticizers, plasticizing agents, binders or binding agents, generally constitute between approximately 0.5 wt % to about 15 wt % of the chewing gum. Water-soluble softeners may include glycerin, propylene glycol, and combinations thereof.

Syrups or high-solids solutions of sugars and/or sugar alcohols such as sorbitol solutions, hydrogenated starch hydrolysates (HSH), corn syrup and combinations thereof, may also be used. In the case of sugar gums, corn syrups and other dextrose syrups (which contain dextrose and significant amounts higher saccharides) are most commonly employed. These include syrups of various DE levels including high-maltose syrups and high fructose syrups. In some cases, low-moisture syrups can replace some or all of the bulking agents typically use, in which case usage levels of the syrup may extend up to 50 wt. % or more of the total gum composition. In the case of sugarless products, solutions of sugar alcohols including sorbitol solutions and hydrogenated starch hydrolysate syrups are commonly used.

Also useful are syrups such as those disclosed in U.S. Pat. No. 5,651,936 and US 2004-234648 which are incorporated herein by reference. Such syrups serve to soften the initial chew of the product, reduce crumbliness and brittleness and increase flexibility in stick and tab products. They may also control moisture gain or loss and provide a degree of sweetness depending on the particular syrup employed.

In some embodiments, an active agent such as a drug, a dental health ingredients or dietary supplement can be used in combination with the gums and gum bases of the present invention. In such cases, the active agent may be incorporated into the gum base, the chewing gum or into associated non-gum portions of a finished product such as into a coating or a candy layer. In some cases, the active may be encapsulated to control its release or to protect it from other product ingredients or environmental factors.

The chewing gum formulations provided herein may also comprise one or more other ingredients conventional in the art, such as gum emulsifiers, colorants, acidulants, fillers, antioxidants and the like. Such ingredients may be used in the present chewing gum formulations in amounts and in accordance with procedures well known in the art of chewing gum manufacture.

Chewing gum is generally manufactured by sequentially adding the various chewing gum ingredients, including the gum base, to commercially available mixers known in the art. After the ingredients have been thoroughly mixed, the chewing gum mass is discharged from the mixer and shaped into the desired form, such as by rolling into sheets and cutting into sticks, tabs or pellets or by extruding and cutting into chunks.

In some embodiments, the chewing gum may be prepared according to a batch process. In such a process, the ingredients are mixed by first melting the gum base and adding it to the running mixer. The gum base may alternatively be melted in the mixer. Color and emulsifiers may be added at this time.

A chewing gum softener such as glycerin can be added next along with a portion of the bulking agent. Further portions of the bulking agent may then be added to the mixer. Flavoring agents are typically added with the final portion of the bulking agent. The entire mixing process typically takes from about five to about fifteen minutes, although longer mixing times are sometimes required.

In other embodiments, it may be possible to prepare the gum base and chewing gum in a single high-efficiency extruder as disclosed in U.S. Pat. No. 5,543,160. Chewing gums of the present invention may be prepared by a continuous process comprising the steps of: a) adding gum base ingredients into a high efficiency continuous mixer; b) mixing the ingredients to produce a homogeneous gum base, c) adding at least one sweetener and at least one flavor into the continuous mixer, and mixing the sweetener and flavor with the remaining ingredients to form a chewing gum product; and d) discharging the mixed chewing gum mass from the single high efficiency continuous mixer. In yet another alternative, a finished gum base may be metered into a continuous extruder along with other gum ingredients to continuously produce a chewing gum composition.

The resultant chewing gums may be formed into sticks, tabs, chunks, tapes, coated or uncoated pellets or balls or any other desired form. In some embodiments, the chewing gum formulation may be used as a component of a greater confectionery product, for example as a center in a hard candy such as a lollipop or as one or more layers of a layered confection which also comprises non-gum confectionery layers.

Of course, many variations on the basic gum base and chewing gum mixing processes are possible.

### EXAMPLES

The following examples of the invention and comparative run illustrate certain aspects and embodiments of the present invention, but do not limit the invention described and claimed. Amounts listed are in weight percent, based upon the total weight of the gum base, or chewing gum, as the case may be.

### Examples 1-6

Polyacrylate Microparticles Polyacrylate microparticles (Ultra-Removable Adhesive) were acquired from Avery Dennison.

Gum Bases Three gum bases were prepared, the formulas of which are provided below in Table 1. Briefly, Gum Base A was used as a control, and was based upon a commercial formula known to be strongly adhesive to concrete. Gum Base B was formulated to have reduced adhesion to environmental surfaces. Gum Base C comprised polyacrylate microparticles as described herein.

TABLE 1

| | Gum Base A | Gum Base B | Gum Base C |
|---|---|---|---|
| | (strongly adhesive | (sample according | (micro- |
| Ingredient | sample) | to WO-01024640) | particles) |
| Butyl Rubber | 8.67 | 10.78 | — |
| Polyisobutylene | 1.60 | — | — |
| Polyvinyl acetate | 23.91 | 23.72 | — |
| Terpene resin | 22.24 | 31.81 | — |
| Hydrogenated | 17.69 | 29.87 | — |
| vegetable oil | | | |
| Lecithin | 3.23 | — | — |
| Calcium carbonate | 22.60 | 3.77 | — |
| BHA | 0.06 | 0.05 | — |
| Polyacrylate | — | — | 100.00 |
| microparticles | | | |
| Total | 100.00 | 100.00 | 100.00 |

Gum Base A was made in a sigma blade mixer at 120° C. For a batch of 3000 gram, gum base A was made in according to the sequence shown in Table 2, below.

TABLE 2

| | | addition time |
|---|---|---|
| Gum base A | % | (hr:min) |
| Butyl rubber | 8.67 | start |
| Polyisobutylene | 1.6 | start |
| calcium carbonate | 15 | Start |
| terpene resin | 10 | Start |
| terpene resin | 12.24 | 0:30 |
| calcium carbonate | 7.6 | 0:30 |
| polyvinyl acetate | 13.91 | 0:40 |
| polyvinyl acetate | 10 | 0:50 |
| hydrogeneated | 10 | 1:00 |
| vetetable oil | | |
| hydrogeneated | 7.69 | 1:10 |
| vetetable oil | | |
| Lecithin | 3.23 | 1:10 |
| BHA | 0.06 | 1:10 |
| Done | | 1:30 |

Gum Base B was made in a sigma blade mixer at 120° C. For a batch of 3000 gram, Gum Base B was made in according to the sequence shown in Table 3, below.

TABLE 3

| | | addition time |
|---|---|---|
| Gum base B | % | (hr:min) |
| Butyl rubber | 10.78 | start |
| calcium carbonate | 3.77 | start |
| terpene resin | 20 | start |
| terpene resin | 11.81 | 0:30 |
| polyvinyl acetate | 13.72 | 0:40 |
| polyvinyl acetate | 10 | 0:50 |
| hydrogeneated | 10 | 1:00 |
| vetetable oil | | |
| hydrogeneated | 10 | 1:10 |
| vetetable oil | | |
| hydrogeneated | 9.87 | 1:20 |
| vetetable oil | | |
| BHA | 0.05 | 1:20 |
| Done | | 1:40 |

Chewing Gums Six chewing gum formulations were prepared, two comparative and four inventive. Example 1, a comparative formulation, was prepared using Gum Base A, known to be strongly adhesive to concrete. Example 2 was prepared using Gum Base B and so appropriate for use as a reduced adhesion control/comparative example. Examples 3-6 were prepared using a combination of Gum Base B (reduced adhesion control) and inventive Gum Base C.

Chewing Gums 1-6 were made in a 1000 gram batch sigma blade mixer. The gum base and bulk sweeteners (sorbitol) were pre-heated in 70° C. oven for 30 minutes. The blend of gum base and sorbitol was then added in the running mixer (front blade speed 32 rpm), the other ingredients (except flavor) were added immediately and mixed for four to five minutes. The flavor was then added and mixed for an additional 4 to 5 minutes until a homogeneous appearance was achieved.

The formulations for Examples 1-6 are shown in Table 4, below.

TABLE 4

| | | Example 2 | | | | |
|---|---|---|---|---|---|---|
| | Example 1 | (Reduced | | | | |
| | (Adhesive | adhesion | Example 3 | Example 4 | Example 5 | Example 6 |
| Ingredient | control) | control) | (Inventive) | (Inventive) | (Inventive) | (Inventive) |
| Gum Base A | 32.33 | — | — | — | — | — |
| Gum Base B | — | 33.67 | 10.00 | 16.50 | 23.00 | 23.47 |
| Gum Base C | — | — | 23.00 | 16.50 | 10.00 | 10.20 |
| (Micro- | | | | | | |
| particles) | | | | | | |
| Sorbitol | 45.50 | 58.60 | 59.89 | 59.89 | 59.89 | 58.60 |
| Calcium | 12.74 | — | — | — | — | — |
| Carbonate | | | | | | |
| Glycerin | 3.92 | 4.08 | 4.00 | 4.00 | 4.00 | 4.08 |
| Maltitol | 2.02 | — | — | — | — | — |
| Peppermint | 1.91 | 1.99 | 1.49 | 1.49 | 1.49 | 1.99 |
| Flavor | | | | | | |
| Lecithin | 0.44 | 0.46 | 0.45 | 0.45 | 0.45 | 0.46 |
| Menthol | 0.34 | 0.36 | 0.35 | 0.35 | 0.35 | 0.36 |
| Encapsulated | 0.33 | 0.35 | 0.34 | 0.34 | 0.34 | 0.35 |
| Acesulfame K | | | | | | |
| Encapsulated | 0.33 | 0.35 | 0.34 | 0.34 | 0.34 | 0.35 |
| Aspartame | | | | | | |
| Aspartame | 0.14 | 0.14 | 0.14 | 0.14 | 0.14 | 0.14 |
| Total | 100.00 | 100.00 | 100.00 | 100.00 | 100.00 | 100.00 |

Both Examples 3 and 4 were very elastic, exhibiting good shape memory. Examples 5 and 6 were closer to conventional gum, and could be sheeted and cut through.

Removability The removability of the chewing gums prepared at Examples 1-6 was tested as follows.

Cud preparation: The gum samples were immobilized in a metal sieve and immersed in 30° C. circulating water for 16 hours, then finger kneaded in 30° C. water for 2 minutes.

Gum cud placement on paver: A concrete paver was rinsed with tap water and air dried overnight. The paver was set on flat ground with the flat surface face up. A fresh gum cud was placed in the center of the paver. The cud was immediately covered by a silicone pad with another paver on the top. A person weighing approximately 200 lbs wearing the flat-heel shoes stepped on the paver for 2 seconds.

Gum cud ageing: 45° C./60RH for 24 hours, and then ambient ageing over night.

Removability Test: Power Wash (1550 PSI). The nozzle angle was set at 60 degrees from the ground, and the spray pattern was set to a fan shape covering 3 cm width on ground when the nozzle was held 40 cm from the cud. The cud was washed for up to 1 minute. A photo was taken before and after the removal test, using a one cent coin as a reference mark for photographic analysis. The percentage of residue remaining after pressure washing was estimated from the after photo. If the cud was completely removed during power wash, the removal time was recorded.

The results of the removability test are summarized below in Table 5.

TABLE 5

| | Example | Wash time | % Residue |
|---|---|---|---|
| Example | Description | (sec) | Remaining |
| 1 | Adhesive Control | 60 | 95 |
| 2 | Reduced Adhesion | 15 | 0 |
| | Control | | |
| 3 | Inventive—23% | 2 | 0 |
| | Microparticles | | |
| 4 | Inventive—16.5% | 3 | 0 |
| | Microparticles | | |
| 5 | Inventive—10% | 6 | 0 |
| | Microparticles | | |
| 6 | Inventive—10% | 6 | 0 |
| | Microparticles | | |

As shown, each of the inventive chewing gums (according to Examples 3-6) not only showed superior removability as compared to the adhesive control chewing gum formulation, but also showed superior removability as compared to the reduced adhesion control.

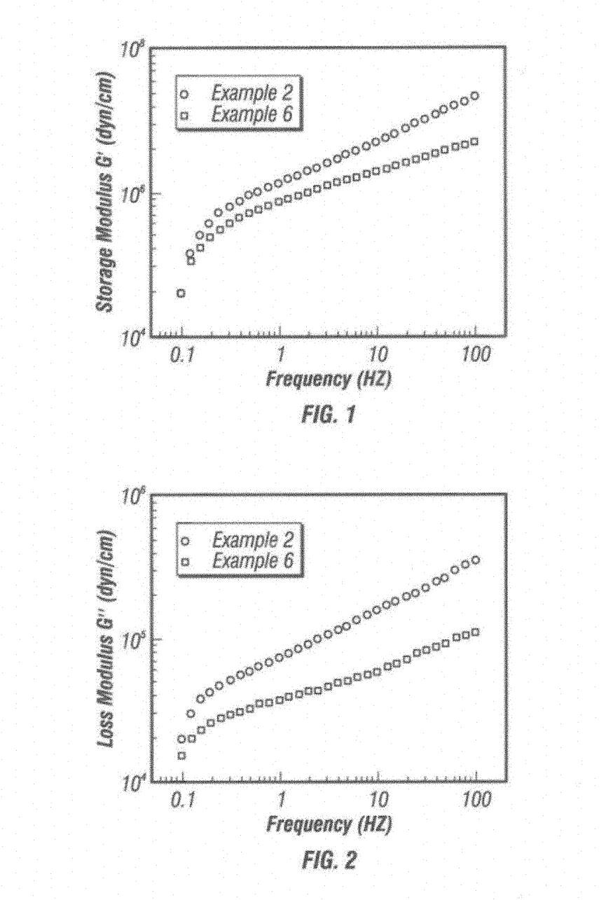

Rheology testing Gum cuds were prepared of the chewing gum formulations of Example 2 (reduced adhesion control) and Example 6 (inventive) following the cud preparation procedure described above. The shear rheology of the two cuds was measured by a TA RDAIII rheometer at 37° C. to determine the effect of the polyacrylate microparticles on chewing gum texture. The results, shown in FIGS. 1 and 2, indicate that the microparticles rendered the gum cud of the inventive chewing gum formulation softer and more elastic than the gum cud of the reduced adhesion control chewing gum formulation.

### Example 7

Chewing Gum A chewing gum according to the present invention, comprising polyacrylate microparticles as a total replacement for gum base, was made according to the formula in Table 6.

TABLE 6

| | Example 7 |
|---|---|
| | (Inventive) |
| Sorbitol | 45.46 |
| Polyacrylate Microparticles | 33.33 |
| (Dry Basis) | |
| Calcium Carbonate | 15.15 |
| Glycerin | 4.04 |
| Flavor | 2.02 |
| | 100.00 |

The polyacrylate microparticles were provided as a 45% aqueous suspension to which was added the sorbitol, calcium carbonate and glycerin. The composition was mixed for 10 minutes to obtain a homogeneous white suspension. The mixture was then heated with continued mixing to obtain a thick but pourable suspension. Flavor was added and the mixture was allowed to dry in an oven at 50° C. overnight.

Removability Samples of commercial gums (Doublemint® and Orbit®) and were obtained for use as controls for adhesion testing. All gum products were pretreated as follows: A small ball of the each gum product was placed in a wire net sample holder and placed in an ultrasonic cleaning device, filled with water. The sample was kneaded for 3 minutes and left in the sonic cleaner to extract water soluble components for a total of 9 minutes, to obtain a simulated gum cud. The surface water of the gum cud was dried before performing the following removability tests.

Concrete Removability Testing:

Each gum cud was applied to a piece of concrete and covered by silicone coated paper before stepping on it for 2 seconds. The adhered samples were placed in an oven at 50° C. for 24 hours. The concrete was then taken out of the oven and allowed to cool to room temperature before attempting to remove the adhered cuds using fingers. The Doublemint® gum cud left a large amount of residue that was very hard to remove. When pulled, the Orbit® gum cud gave a long string and also left a large amount of residue. The gum cud of Example 7 was removed cleanly by hand leaving no residue.

Fabric Removability Testing:

The gum cud of Example 7 was placed on a piece of 100% cotton fabric from a sport shirt and heavy thumb pressure was applied. It was cleanly removable from the cotton fabric using only fingers.

All patents, patent applications, provisional applications, and publications referred to or cited herein are incorporated by reference in their entirety to the extent they are not inconsistent with the explicit teachings of this specification. Further, while only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A chewing gum base comprising non-uniform microparticles containing at least one crosslinked polymer.

2. The chewing gum base of claim 1 wherein the crosslinked polymer has a glass transition temperature of less than about 30° C.

3. The chewing gum base of claim 2 wherein the crosslinked polymer has a glass transition temperature of less than about 10° C.

4. The chewing gum base of claim 3 wherein the crosslinked polymer has a glass transition temperature of less than about 0° C.

5. The chewing gum base of claim 1 wherein the non-uniform microparticles are in the form of polymer composite microparticles.

6. The chewing gum base of claim 1 wherein the non-uniform microparticles are in the form of hollow shell microparticles.

7. The chewing gum base of claim 1 wherein the non-uniform microparticles are in the form of core-shell microparticles.

8. The gum base of claim 1 wherein the crosslinked polymer has a complex modulus G* at 25° C. of less than about 10⁹ dyne/cm².

9. The chewing gum base of claim 1 wherein the crosslinked polymer has a complex modulus G* at 25° C. of greater than about 10⁴ dyne/cm².

10. The chewing gum base of claim 1 wherein the microparticles comprise a food grade polymer.

11. A chewing gum base comprising microparticles containing at least one crosslinked polymer having diameter largest diameter of less than 100 nanometers.

12. The chewing gum base of claim 11 wherein the microparticles comprise a polyacrylate, a polyurethane, or mixtures thereof.

13. The chewing gum base of claim 11, wherein the microparticles are formed from a polyacrylate of at least one acrylate monomer comprising isooctyl acrylate, 4-methyl-2-pentyl-acrylate, 2-methylbutyl acrylate, isoamyl acrylate, sec-butyl acrylate, n-butyl

14. The chewing gum base of claim 13, wherein the at least one acrylate monomer comprises isoctyl acrylate, 2-ethylhexyl acrylate, n-butyl acrylate, or mixtures thereof.

15. The chewing gum base of claim 11 wherein the non-uniform microparticles comprise polymer composite microparticles, hollow shell microparticles, core-shell microparticles or a mixture thereof.

16. The chewing gum base of claim 11 wherein the crosslinked polymer has a glass transition temperature of less than about 30° C.

17. The chewing gum base of claim 11 wherein the crosslinked polymer has a glass transition temperature of less than about 10° C.

18. The chewing gum base of claim 11 wherein the crosslinked polymer has a glass transition temperature of less than about 0° C.
